(19) United States
(12) Patent Application Publication
(10) Pub. No.: US 2014/0244357 A1
(43) Pub. Date: Aug. 28, 2014

(54) Inducing Customer Store Visits Via Mobile Application

(71) Applicant: WAL-MART STORES, INC., Bentonville, AR (US)

(72) Inventor: David Patterson, Berkeley, CA (US)

(73) Assignee: Wal-Mart Stores, Inc., Bentonville, AR (US)

(21) Appl. No.: 13/779,629

(22) Filed: Feb. 27, 2013

(51) Int. Cl. G06Q 30/02

(52) U.S. Cl. CPC G06Q 30/0203
USPC 705/7.32

(57) ABSTRACT

The present disclosure extends to methods, systems, and computer program products for motivating customers to voluntarily provide information about themselves to retailers. The retailer provides the customer with an application for a mobile device, which application is configured for detecting the customer's presence in the retailer's store when the application is enabled. The application is enabled by the customer providing the requested information. When the application detects the customer's presence in the store for a selected time period or when the customer makes a purchase, then the retailer awards a contribution to charity. This charitable contribution is an incentive for the customer to use the mobile application in the store.

### BACKGROUND

Companies routinely spend large amounts of money for advertising in publications, mailings, and online. Must of this advertising is misdirected in that it rarely offers customer-specific information about products offered by the company. However, it is difficult to obtain information about customers so that advertising can be directed in a targeted manner. It would be advantageous to a company to be able to motivate customers to voluntarily provide information about themselves. If retailers had such customer information, then the retailer would benefit by being able to direct information about product offerings to those most likely to be interested in them, and customers would benefit by receiving information about products of actual interest.

These problems apply even with the use of computers and current computing systems. The disclosed methods and systems herein, provide efficient and cost effective methods and systems for merchants to obtain information about their customers. The disclosed methods, features, systems, and computer program products also operate to motivate customers to visit the merchant's store on a frequent basis, which undoubtedly leads to greater sales volume. Moreover, through their visits to the stores and their purchases customers do something for the good of the public by partnering with the retailer to provide charitable contributions.

The present disclosure extends to methods, systems, and computer program products for motivating customers to voluntarily provide information about themselves to retailers. The retailer provides the customer with an application for a mobile device, which application is configured for detecting the customer's presence in the retailer's store when the application is enabled. The application is enabled by the customer providing the requested information. When the application detects the customer's presence in the store for a selected period of time or when the customer makes a purchase, then the retailer awards a contribution to charity. This charitable contribution is an incentive for the customer to use the mobile application in the store. The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example computer architecture that facilitates different implementations described herein;

FIG. 3 illustrates a flow chart of an example method according to one implementation.

### DETAILED DESCRIPTION

The present disclosure extends to methods, systems, and computer program products for providing merchant database updates for new product items. In the following description of the present disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

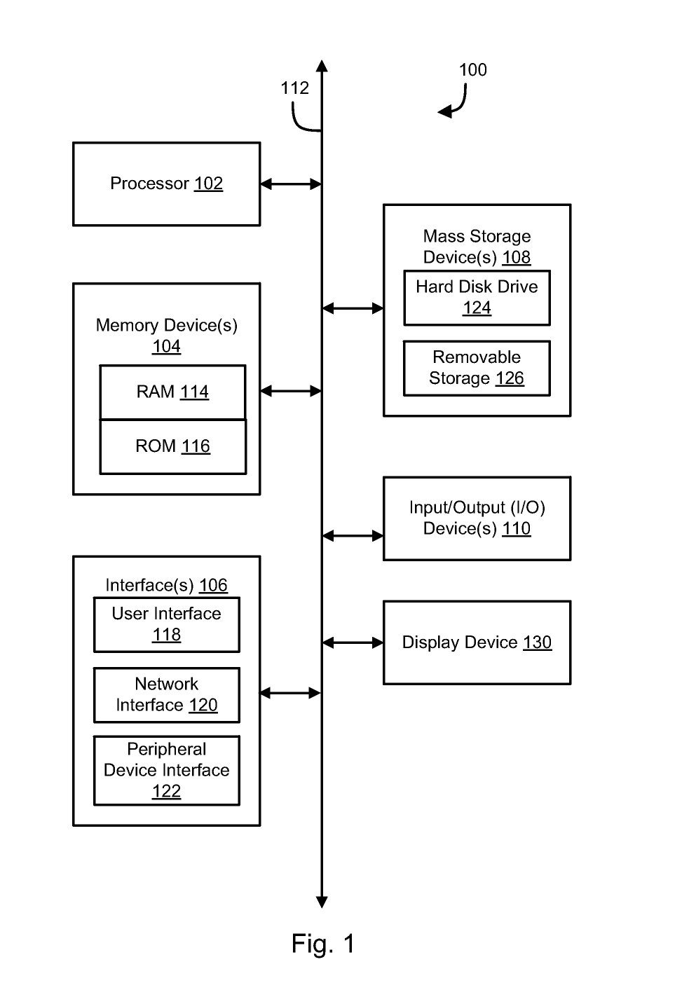

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

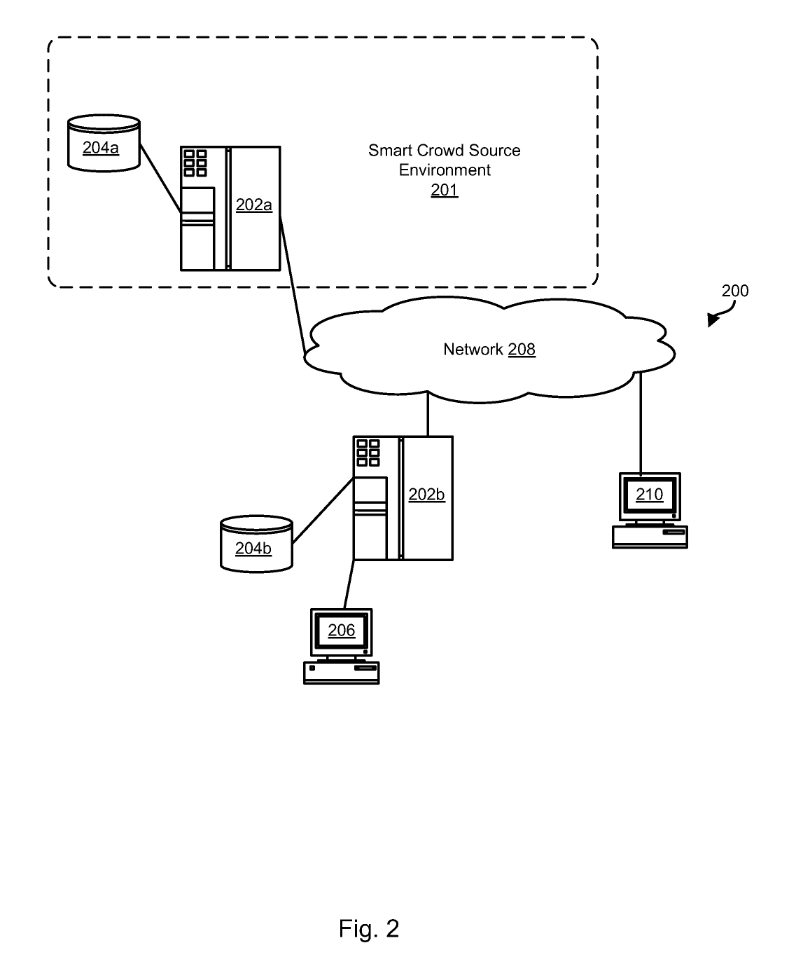

FIG. 2 illustrates an example of a computing environment 200 and a smart crowd source environment 201 suitable for implementing the methods disclosed herein. In some implementations, a server 202a provides access to a database 204a in data communication therewith, and may be located and accessed within a brick and mortar retail location. The database 204a may store customer attribute information such as a user profile as well as a list of other user profiles of friends and associates associated with the user profile. The database 204a may additionally store attributes of the user associated with the user profile. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

As used herein, a smart crowd source environment is a group of users connected over a network that are assigned tasks to perform over the network. In an implementation the smart crowd source may be in the employ of a merchant, or may be under contract with on a per task basis. The work product of the smart crowd source is generally conveyed over the same network that supplied the tasks to be performed. In the implementations that follow, users or members of a smart crowd source may be tasked with reviewing the classification of new product items and the hierarchy of products within a merchant's database.

A server 202b may be associated with a classification manager or other entity or party providing classification work. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

As used herein, a classification model pipeline is intended to mean plurality of classification models organized to optimize the classification of new product items that are to be added to a merchant database. The plurality of classification models may be run in a predetermined order or may be run concurrently. The classification model pipeline may require that new product items be processed by all of the classification models within the pipeline, or may allow the classification process to stop before all of the classification models are run if predetermined thresholds are not met.

It is to be further understood that the phrase “computer system,” as used herein, shall be construed broadly to include a network as defined herein, as well as a single-unit work station (such as work station 206 or other work station) whether connected directly to a network via a communications connection or disconnected from a network, as well as a group of single-unit work stations which can share data or information through non-network means such as a flash drive or any suitable non-network means for sharing data now known or later discovered.

Companies routinely spend large amounts of money for advertising in publications, via mailings, and online. However, much of this advertising is misdirected and rarely offers customer-specific information because retailers typically do not know who their customers are. This is generally true in the sense that retailers do not generally know either (1) the names and contact information of their customers, or (2) behavioral and demographic information of their customers. If a customer visits a store without making a purchase, there is generally no way for the retailer to know that. Even if a customer visits a store and makes a purchase, the retailer typically does not collect information about the customer and the purchase. It is useful to a retailer to have both identifying information and behavioral and demographic information about its customers, because the more a company knows about a customer, the more the retailer can tailor its activities to enhance the customer's overall experience with the company. For example, if the retailer knows information about gender, domestic status, whether or not there are children in the household, whether or not the customer is a homeowner, income level, age, recent major purchases, and a myriad of similar information, the retailer can use that information to direct advertising to the customer in a targeted way instead of using a shotgun approach that may or may not have a likelihood of interesting a particular customer.

The ability of a retailer to induce customers to provide information about themselves, either through online contact with the retailer or through actual in-store visits, has high commercial value. As suggested above, if the retailer has information about the customer's name, contact information, actual or likely purchasing habits, recent purchases, and the like, this information can be used to target advertising to the customer. For example, if the retailer had information that the customer had recently purchased a boat, then the retailer could make the customer aware of its boating products. This benefits the retailer, because the customer is more likely to make purchases if he or she knows of product offerings that are actually of interest. This also benefits the customer, because it is less likely that the customer will be burdened with receiving advertisements about product offerings that are of little or no interest.

Therefore, a goal of the presently described method and system is to induce customers and potential customers to provide information to the retailer so the retailer can use that information for improving the customer-retailer relationship and providing advertisements to the customers concerning products that the customer is actually or likely to be interested in. Advertising is usually poorly directed, because it is usually dispersed using a random, shotgun approach. Because of the possibility of targeting advertising to customers and potential customers over the internet, information about these people is very valuable to large retailers of general consumer merchandise, as well as to other retailers. Said in another way, the random, shotgun approach to advertising that attempts to induce customers to visit the retailer's store is not particularly effective because the retailer lacks the information to know how to capture the customer's interest or to reach the customers that would have an interest in the products if they only knew about them.

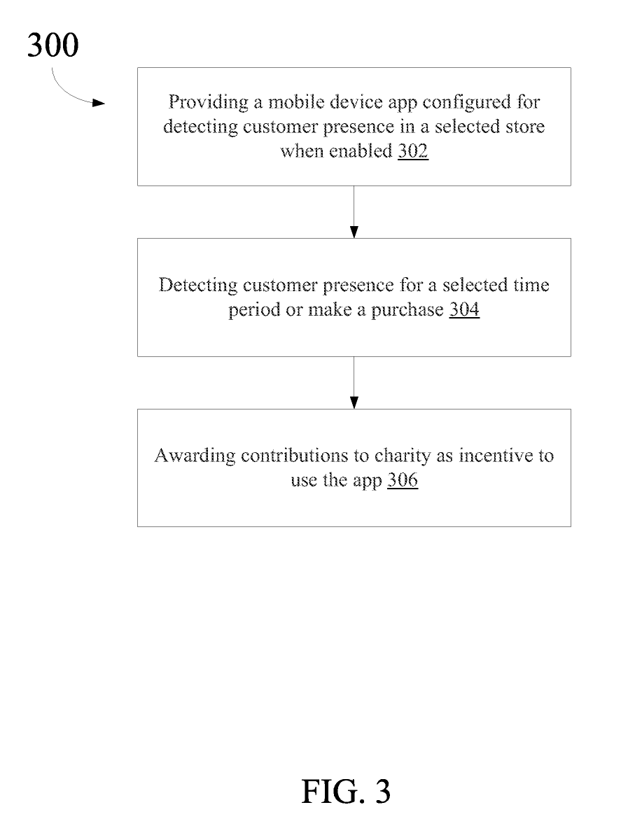

FIG. 3 is a flow chart that describes a method 300 of motivating a customer to voluntarily providing information about themselves, which the company can then use for marketing purposes and improved customer relations. The method motivates the customer to spend time in the store. Since many companies lack a “loyalty” reward program, the method gives these companies an opportunity to motivate customers to register with the company, i.e., provide identifying information such as name, address, email address, and other contact information, as well other information the company may wish to collect. The company provides 302 the customer with a mobile device application (“app”) that is configured, in connection with the company's computer system, network or processor, such as is shown in FIG. 1 or FIG. 2 or the equivalent, to detect the customer's assumed presence in a selected store by utilizing detection or identification technology known to those of ordinary skill in the field, in which a company's computer system, network or processor may detect the presence and entry time of a user's mobile device. The mobile device can be any such device now known or known in the future. Illustrative mobile devices include so-called smart phones, tablet computers, personal digital assistants, mobile computers, and the like. The app is enabled by the customer registering with the company by means of providing information selected by the company, which would generally include at least name and contact information. Typically, the contact information would include at least a verifiable email address. Other contact information that the company might want could include mailing address, telephone numbers, and the like.

When the app detects 304 that the customer has been in the store for a selected length of time or that the customer has made a purchase in lieu of remaining in the store for the selected period of time, then the company awards 306 a contribution to charity. For example, the company might set the period of time required for the person to be in the store to trigger the making of the charitable contribution at 15 minutes. Other periods of time could be selected. The company should select this period of time by balancing an amount of time likely to lead to a purchase of the company's products, but not being so long that it acts as a disincentive for the customer to participate in the charitable contribution program. The award to charity is used as a motivation to the customer to use the app, the use of which requires the voluntary submission of the customer information that the company would like to have. The charitable contribution acts as incentive because the customers feel like they are providing a useful service for the public good when they visit the store or make a purchase. The charitable contribution may be directed by the company or the customer. That is, it is expected that the company will direct the amount of the charitable contribution according to criteria it determines, the recipient of the charitable contribution could be selected by either the company or the customer according to this method. The company would hope that the customer will be motivated to visit the store frequently, whether the customer buys anything or not. In this way, the customer may get in the habit of dropping in at the store, perhaps thinking that he will get something (the charitable contribution) for little expenditure of effort or money. From the company's point of view, of course, when people go to a store, they generally buy something.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for motivating a customer to provide selected information to a company, the method comprising:
providing to the customer a mobile device software application configured for detecting the customer's presence in a selected store after the application has been enabled, wherein the application is enabled by the customer providing the selected information to the company and installing the application on a mobile device;
with a processor, detecting the mobile device's presence in the store for a selected time period, wherein the mobile device's presence is interpreted as the customer's presence, or until the customer makes a purchase, if the purchase is made before the selected time period is reached; and
awarding a contribution to charity once the selected time period has elapsed or the purchase is made, wherein the contribution to charity comprises a motivation for the customer to provide the selected information.

2. The method of claim 1, wherein the selected information comprises the customer's name and the customer's contact information.

3. The method of claim 2, wherein the customer's contact information comprises at least a verifiable email address.

4. The method of claim 3, wherein the contact information further comprises a mailing address or a telephone number.

5. The method of claim 2, wherein the selected information further comprises behavioral information, demographic information, or both behavioral and demographic information.

6. The method of claim 1 wherein the mobile device is a smart phone.

7. The method of claim 1 wherein the mobile device is a tablet computer.

8. The method of claim 1 wherein the mobile device is a personal digital assistant.

9. The method of claim 1 wherein the charitable contribution is directed by the company.

10. The method of claim 1 wherein the charitable contribution is directed by the customer.

11. A system for motivating a customer to provide selected information to a company comprising: one or more processors and one or more memory devices operably coupled to the one or more processors and storing executable and operational data, the executable and operational data effective to cause the one or more processors to:
provide to the customer a mobile device software application configured for detecting the customer's presence in a selected store after the application has been enabled, wherein the application is enabled by the customer providing the selected information to the company and installing the application on a mobile device;
detect the mobile device's presence in the store for a selected time period, wherein the mobile device's presence is interpreted as the customer's presence, or until the customer makes a purchase, if the purchase is made before the selected time period is reached; and
award a contribution to charity once the selected time period has elapsed or the purchase is made, wherein the contribution to charity comprises a motivation for the customer to provide the selected information.

12. The system of claim 11, wherein the selected information comprises the customer's name and the customer's contact information.

13. The system of claim 12, wherein the customer's contact information comprises at least a verifiable email address.

14. The system of claim 13, wherein the contact information further comprises a mailing address or a telephone number.

15. The system of claim 12, wherein the selected information further comprises behavioral information, demographic information, or both behavioral and demographic information.

16. The system of claim 11 wherein the mobile device is a smart phone.

17. The system of claim 11 wherein the mobile device is a tablet computer.

18. The system of claim 11 wherein the mobile device is a personal digital assistant.

19. The system of claim 11 wherein the charitable contribution is directed by the company.

20. The system of claim 11 wherein the charitable contribution is directed by the customer.
